(19) United States
(12) Patent Application Publication
(10) Pub. No.: US 2022/0167057 A1
(43) Pub. Date: May 26, 2022

(54) MANAGING USER UPLOADED CONTENT

(71) Applicant: ARRIS Enterprises LLC, Suwanee, GA (US)

(72) Inventor: Krishna Prasad PANJE, Bengaluru (IN)

(73) Assignee: ARRIS Enterprises LLC, Suwanee, GA (US)

(21) Appl. No.: 17/532,705

(22) Filed: Nov. 22, 2021

Related U.S. Application Data
(60) Provisional application No. 63/117,016, filed on Nov. 23, 2020.

(51) Int. Cl. H04N 21/472; H04N 21/4147; H04N 21/418; H04N 21/488; H04N 21/81

(52) U.S. Cl. CPC H04N 21/47217; H04N 21/4147; H04N 21/814; H04N 21/4884; H04N 21/4182

(57) ABSTRACT

Methods and systems of managing user uploaded content are shown and disclosed. In one embodiment, the method includes receiving uploaded content from a first user device, and storing the received content in storage associated with a network-based digital video recorder (nDVR). The method additionally includes receiving a request for playback of the stored content from a set top box or a second user device, and delivering the stored content to the set top box or the second user device. The method further includes delivering an emergency notification with the stored content to the set top box or the second user device.

### CROSS REFERENCE TO RELATED APPLICATIONS

This application claims the benefit of U.S. Provisional Patent Application No. 63/117,016 filed on Nov. 23, 2020.

### BACKGROUND

The subject matter of this application relates to managing user uploaded content, in particular systems and methods for storing user uploaded content in a network Digital Video Recorder system and delivering the stored content to a set top box or user device.

Users create a lot of personal recordings on their cameras, smart phones, etc. The users are able to upload their personal recordings to servers of various over-the-top (OTT) providers. However, each OTT provider has their own user interface and requirements for uploading and playback through a non-MSO network. MSOs are thus unable to insert business media into the content (e.g., targeted advertisements, banners, notifications, etc.) or modify the content.

Network Digital Video Recorder (nDVR) systems provide a user, via a single user interface, the ability to record various content, such as multiple system operator (MSO) network content, for home consumption or across one or more devices away from home. What is desired, therefore, are systems and/or methods of managing user uploaded content through a single user interface and with the processing and delivering capabilities of a nDVR system to produce a consistent user experience across several devices and to allow MSOs to insert business media into the user uploaded content.

### BRIEF DESCRIPTION OF THE DRAWINGS

For a better understanding of the invention, and to show how the same may be carried into effect, reference will now be made, by way of example, to the accompanying drawings, in which:

FIG. 1 is a high-level block diagram of an example of a network for managing user uploaded content;

FIG. 2 is a block diagram of an example of a nDVR system;

FIG. 3 is a flowchart illustrating an example process of managing user uploaded content; and

FIG. 4 is a block diagram of an example of a hardware configuration operable to manage user uploaded content.

### DETAILED DESCRIPTION

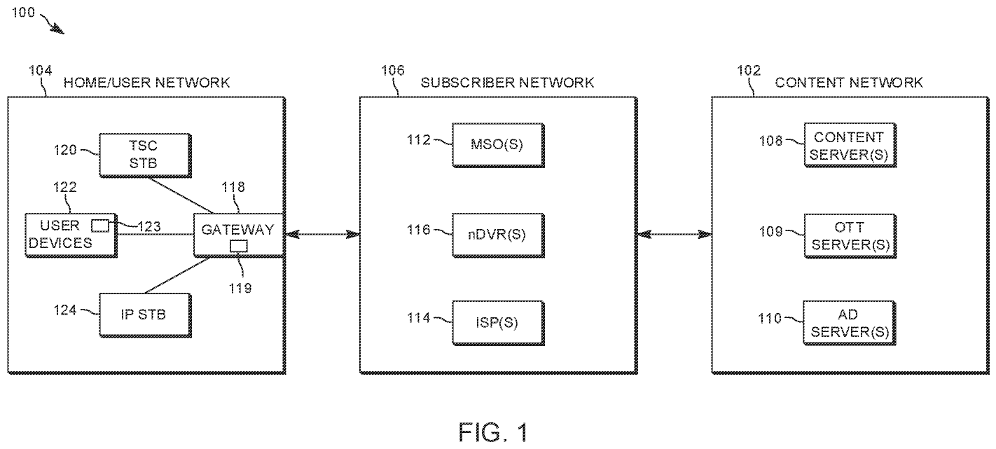

Referring to FIG. 1, an example is shown of a network environment 100 for providing content from a content network 102 to a home or user network 104 via a provider, access, or subscriber network 106, and for managing uploaded content from a user. Content includes any type of video or audio media, such as movies, television shows, music, radio, advertisements, etc. Uploaded content includes any of the above content that is uploaded by a user.

Content network 102 includes one or more content servers 108, one or more over-the-top servers 109, and one or more advertisement servers 110. The content, over-the-top, and advertisement servers store content that is provided to home network 104. Content server(s) 108 provide content via a multiple system operator (MSO) and/or an internet service provider. Over-the-top servers (OTT) 109 provide content only via over the top streaming for at least one client device of the home network. Advertising server(s) 110 provide advertising content, such as targeted advertising content.

Subscriber network 106 includes one or more Multiple System Operator (MSO) systems 112, which includes multiple cable TV systems and/or direct satellite TV systems. For example, MSO system 112 may include one or more headends, regional headends, a network architecture of fiber optic, twisted pair, and/or co-axial lines, and/or amplifiers. Subscriber network 112 also includes one or more Internet Service Providers (ISP) 114. Each ISP 114 includes a Point of Presence (POP) that connect to Network Access Points (NAP), such as via routers and a T3 backbone. In the example shown in FIG. 1, subscriber network 106 includes one or more network Digital Video Recorder (nDVR) systems 116, which may be part of and/or separate from MSO systems 112. Various content from content network 102 may be recorded and/or stored on nDVR systems 116 based on requests made by users or subscribers. Subscriber network 106 may include other components not explicitly shown in FIG. 1, such as transcoders, streamers, just-in-time (JIT) packagers, etc.

Home/user network 104 includes a gateway 118, a terrestrial, satellite, and/or cable (TSC) set top box 120, user devices 122, and an Internet Protocol (IP) set top box 124. In some embodiments, gateway 118 includes a user content component or apparatus 119, which includes software, hardware, and/or firmware capable of conditioning content uploaded by a user via user devices 122. TSC set top box 120 is operable to connect to a television to deliver television services through traditional terrestrial, satellite, and cable formats. TSC set top box 120 may include a digital video recorder and/or may have a graphic user interface (GUI) that may be assessed by the user via the television to which TSC set top box 120 is connected. User devices 122 may be any device that may receive content, such as smart phones, mobile phones, tablet computers, smart watches and other wearables, gaming systems, etc. The user devices may have a GUI that may be accessed by the user via the screen on the device. Additionally, user devices 122 includes a user content component or apparatus 123, which includes software, hardware, and/or firmware capable of uploading user content and receiving user input for conditioning of that content and for requesting playback. IP set top box 124 is operable to connect to a television over the Internet instead of being delivered through traditional terrestrial, satellite, and cable formats. The IP set top box may include a digital video recorder and/or may have a GUI that may be accessed by the user via the television to which the IP set top box is connected.

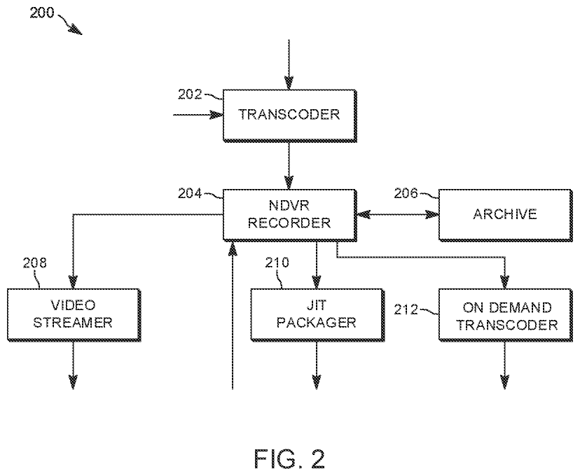

Referring to FIG. 2, an example nDVR system 116 is shown, which is generally indicated at 200. The nDVR system 200 includes a primary transcoder 202, such as a multi-rate transcoder, that is operable to communicate with nDVR recorder 204 and receive content in one format and change, or transcode, that format into one or more different formats. The nDVR recorder 204 is operable to record and store content based on requests for content made by users or subscribers. nDVR 204 communicates with transcoder 202, storage or archive 206, video streamer 208, just-in-time (JIT) packager 210, on-demand transcoder 212, TSC set top box 120, user devices 122, and IP set top box 124.

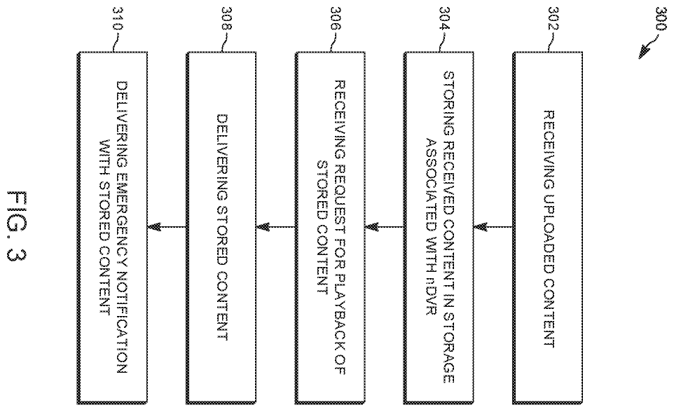

Storage or archive 206 is a data storage device operable to save content (and copies of that content). Archive 206 may include physical storage and/or memory media, such as RAM, ROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. Archive 206 is shown as a separate entity in FIG. 2. However, it is possible that archive 206 is part of nDVR recorder 204. Video streamer 208 is operable to communicate with nDVR recorder 204 and TSC set top box 120. JIT packager 210 is operable to communicate with nDVR recorder 204, user devices 122, and IP set top box 124. JIT packager 210 serves to provide adjustable bit rate (ABR) content to devices that can accept the format, such as a proprietary smart phone, a game console client, or Smart TV client. Other embodiments of nDVR system 200 may include more or less components than shown in FIG. 3. For example, some embodiments of nDVR system 200 may exclude on-demand transcoder 212.

Referring to FIG. 3, a flowchart is shown of an example method or process 300 of managing user uploaded content, which may be performed, for example, by nDVR systems 116, gateway 118, and/or a user content component or apparatus 119 and/or 123. At 302, uploaded content from a user device is received. At 304, the received content is stored in storage associated with a nDVR system.

In some embodiments, the received uploaded content may be conditioned prior to or after the content is stored in the storage. For example, captions (e.g., WebVTT) and/or metadata (e.g., for bookmarks, captions, tags, etc.) may be added, deleted, or revised for the uploaded content. Additionally, the uploaded content may be edited, such as shortened, elongated (via slow motion), edited to remove audio or include only audio, one or more portions removed (e.g., show only or remove only close-up video data portion), resolution changed (e.g., from high to low resolution or vice-versa), etc. Moreover, the uploaded content may be transcoded to correspond with decoding capabilities of user devices and set top boxes. Furthermore, a digital rights management (DRM) scheme of the uploaded content (e.g., Playready DRM) may be modified or changed to correspond with access capabilities of user devices and set top boxes. In some embodiments, one or more copies of the stored content may be made and conditioning may be performed on those copies. In other embodiments, the conditioning may be performed on the uploaded content. In some embodiments, a user interface may be provided to the first user device, a set top box, or a second user device to receive user input via the user interface to condition the uploaded content based on the user input.

At 306, a request for playback of the stored content is received from one or more user devices and/or set top boxes. At 308, the stored content is delivered to one or more user devices and/or a set top box, such as the requesting user device and/or requesting set top box (and/or other user devices and/or set top boxes), such as in response to receiving the request for playback. At 310, one or more emergency notifications are delivered with (e.g., embedded or merged with) and/or separate from the stored content to the user device(s) and/or set top box(es). For example, an Emergency Alert System (EAS) message may be delivered with and/or separate from the stored content. In some embodiments, the emergency notification(s) may be delivered based on the geolocation of the receiving user devices and/or set top boxes. In some of those embodiments, only the user devices without a cell service provider or connection may receive the emergency notifications.

In some embodiments, method 300 may additionally, or alternatively, include delivering advertisement content, such as targeted advertisement content, with the stored content (or separate from the stored content). For example, advertisement banners or notification may be embedded or merged with the stored content. Although FIG. 3 shows particular steps for a process of managing user uploaded content, other examples of the process may add, omit, replace, repeat, and/or modify one or more steps.

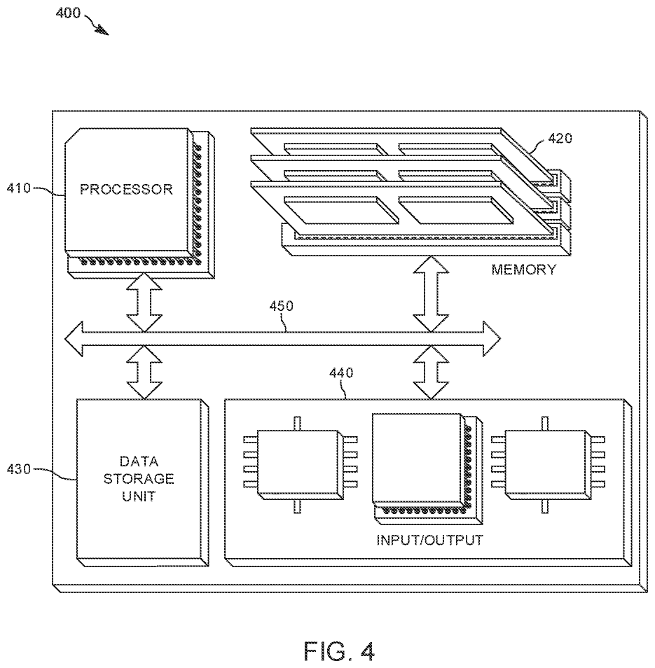

Referring to FIG. 4, a hardware configuration 400 operable to facilitate automatically updating shared content is shown. The hardware configuration may be configured to implement or execute one or more of the processes performed by any of the various components, engines, modules, and devices described in the present disclosure, including nDVR systems 116, gateway 118, and/or a user content component or apparatus 119 and/or 123. The hardware configuration 400 may include a processor 410, a memory 420, a storage device 430, and an input/output device 440. Each of the components 410, 420, 430, and 440 may, for example, be interconnected using a system bus 450. The processor 410 may be capable of processing instructions for execution within the hardware configuration 400. In one implementation, the processor 410 may be a single-threaded processor. In another implementation, the processor 410 may be a multi-threaded processor. The processor 410 may be capable of processing instructions stored in the memory 420 or on the storage device 430.

The memory 420 may store information within the hardware configuration 400. In one implementation, the memory 420 may be a computer-readable medium. In one implementation, the memory 420 may be a volatile memory unit. In another implementation, the memory 420 may be a non-volatile memory unit. In some implementations, the storage device 430 may be capable of providing mass storage for the hardware configuration 400. In one implementation, the storage device 430 may be a computer-readable medium. In various different implementations, the storage device 430 may, for example, include a hard disk device, an optical disk device, flash memory or some other large capacity storage device. In other implementations, the storage device 430 may be a device external to the hardware configuration 400.

The input/output device 440 provides input/output operations for the hardware configuration 400. In embodiments, the input/output device 440 may include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a CPE device, IP device, mobile device, or other device. In embodiments, the input/output device may include driver devices configured to send communications to, and receive communications from an advertisement decision system, an advertisement media source, and/or a CDN.

The methods, systems, and apparatuses described in this disclosure enable the identification and retrieval of one or more preferred or requested media renditions of multimedia content, such as uploaded content. A subscriber device may maintain a list of media attributes preferred by the subscriber device and/or one or more users with access to the subscriber device, wherein the list includes preferred media attributes in order from the most requested/received attribute to the least requested/received attribute. When the subscriber device receives a request for multimedia content, the subscriber device may identify one or more media attributes preferred by the subscriber, and media renditions of the multimedia content in each of the identified attributes may be downloaded to the subscriber device.

The subject matter of this disclosure, and components thereof, may be realized by instructions that upon execution cause one or more processing devices to carry out the processes and functions described above. Such instructions may, for example, comprise interpreted instructions, such as script instructions, e.g., JavaScript or ECMAScript instructions, or executable code, or other instructions stored in a computer readable medium.

Implementations of the subject matter and the functional operations described in this specification may be provided in digital electronic circuitry, or in computer software, firmware, or hardware, including the structures disclosed in this specification and their structural equivalents, or in combinations of one or more of them. Embodiments of the subject matter described in this specification may be implemented as one or more computer program products, i.e., one or more modules of computer program instructions encoded on a tangible program carrier for execution by, or to control the operation of, data processing apparatus.

A computer program (also known as a program, software, software application, script, or code) may be written in any form of programming language, including compiled or interpreted languages, or declarative or procedural languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows may also be performed by, and apparatus may also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory may be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter described in this specification have been described. Other embodiments are within the scope of the claims below. For example, the actions recited in the claims may be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of managing user uploaded content, comprising:
receiving uploaded content from a first user device;
storing the received content in storage associated with a network-based digital video recorder (nDVR);
receiving a request for playback of the stored content from a set top box or a second user device;
delivering the stored content to the set top box or the second user device in response to receiving the request for playback; and
delivering an emergency notification with the stored content to the set top box or the second user device.

2. The method of claim 1, further comprising transcoding the stored content to correspond with decoding capabilities of the set top box or the second user device.

3. The method of claim 1, further comprising modifying a digital rights management (DRM) scheme of the stored content to correspond with access capabilities of the set top box or the second user device.

4. The method of claim 1, further comprising delivering one or more advertisement content with the stored content to the set top box or the second user device.

5. The method of claim 1, further comprising conditioning the stored content.

6. The method of claim 5, wherein conditioning the stored content includes adding captions to the stored content.

7. The method of claim 5, wherein conditioning the stored content includes adding metadata to the stored content.

8. The method of claim 5, wherein conditioning the stored content includes transcoding the stored content to correspond with decoding capabilities of the set top box or the second user device.

9. The method of claim 5, further comprising:
providing a user interface to at least one of the first user device, the set top box, or the second user device;
receiving input from the user interface; and
conditioning the stored content based on the received input.

10. The method of claim 9, wherein receiving input from the user interface includes receiving one or more captions from the user interface, and wherein conditioning the stored content based on the received input includes adding the received one or more captions to the stored content.

11. The method of claim 9, wherein receiving input from the user interface includes receiving metadata from the user interface, and wherein conditioning the stored content based on the received input includes adding the received metadata to the stored content.

12. The method of claim 9, wherein receiving input from the user interface includes receiving one or more editing commands from the user interface, and wherein conditioning the stored content based on the received input includes editing the stored content based on the received one or more editing commands.

13. The method of claim 9, further comprising creating a copy of the stored content, and wherein the conditioning is performed on the copy of the stored content.

14. The method of claim 13, wherein the conditioned copy of the stored content is delivered to the set top box or the second user device in response to receiving the request for playback.

15. The method of claim 1, wherein delivering an emergency notification includes delivering the emergency notification with the stored content to the set top box or the second user device based on geolocation of the set top box or the second user device.

16. The method of claim 1, wherein delivering an emergency notification includes delivering the emergency notification embedded with the stored content to the set top box or the second user device.

17. The method of claim 1, wherein delivering an emergency notification includes delivering an Emergency Alert System (EAS) message with the stored content to the set top box or the second user device based on geolocation of the set top box or the second user device.

18. The method of claim 1, wherein receiving a request for playback of the stored content includes receiving the request for playback via a user interface associated with the nDVR.

19. The method of claim 1, wherein the second user device is different from the first user device.
